(19) United States
(12) Patent Application Publication
(10) Pub. No.: US 2023/0296912 A1
(43) Pub. Date: Sep. 21, 2023

(54) PROJECTOR

(71) Applicant: SEIKO EPSON CORPORATION, Tokyo (JP)

(72) Inventor: Takashi TAKEDA, Suwa-shi (JP)

(73) Assignee: SEIKO EPSON CORPORATION, Tokyo (JP)

(21) Appl. No.: 18/183,959

(22) Filed: Mar. 15, 2023

(30) Foreign Application Priority Data
Mar. 17, 2022 (JP) 2022-042278

(51) Int. Cl. G02B 27/42

(52) U.S. Cl. CPC G02B 27/4205

(57) ABSTRACT

A projector includes a self-luminous display element configured to emit image light that is multicolored and has a predetermined wavelength band for each color of light, a first diffraction element configured to diffract the image light from the display element, and a second diffraction element configured to emit the image light while making angular compensation, by diffracting the image light, for angular separation of the image light occurring depending on the wavelength band of each color of light when diffracted by the first diffraction element.

The present application is based on, and claims priority from JP Application Serial Number 2022-042278, filed Mar. 17, 2022, the disclosure of which is hereby incorporated by reference herein in its entirety.

### BACKGROUND

### 1. Technical Field

The present disclosure relates to a compact projector using a hologram.

### 2. Related Art

A rear projection type display apparatus for television as an example application of a projector which utilizes a hologram is known (JP-A-3-13930).

However, although the rear projection type display apparatus which is an aspect of the projector illustrated in JP-A-3-13930 uses a hologram to reduce the thickness of the apparatus, it is designed for television and thus includes, for example, up to a screen onto which an image is to be projected. Thus, even if the apparatus forms a thin television by using a hologram, it is considered that it is desirable that the apparatus form a large screen as a whole, but JP-A-3-13930 does not sufficiently disclose, for example, that the overall size of the apparatus is reduced to the extent that it can be incorporated into another device and high-definition image formation is performed while saving power.

### SUMMARY

A projector according to an aspect of the present disclosure includes a self-luminous display element configured to emit image light that is multicolored and has a predetermined wavelength band for each color of light, a first diffraction element configured to diffract the image light from the display element, and a second diffraction element configured to emit the image light while making angular compensation for angular separation of the image light occurring depending on the wavelength band of each color of light when diffracted by the first diffraction element, by diffracting the image light.

### BRIEF DESCRIPTION OF THE DRAWINGS

FIG. 1 is a conceptual diagram for explaining a projector according to a first embodiment.

FIG. 2 is a conceptual diagram for explaining the occurrence and elimination of angular separation.

FIG. 3 is a conceptual diagram for explaining exposure points in producing a hologram element.

FIG. 4 is a conceptual diagram for explaining example applications of a projector.

FIG. 5 is a conceptual side cross-sectional view for explaining a projector according to a second embodiment.

FIG. 6 is a conceptual diagram for explaining a projector according to a third embodiment.

FIG. 7 is a conceptual diagram for explaining a projector according to a fourth embodiment.

### DESCRIPTION OF EXEMPLARY EMBODIMENTS

### First Embodiment

A projector according to a first embodiment of the present disclosure will be described below with reference to the drawings.

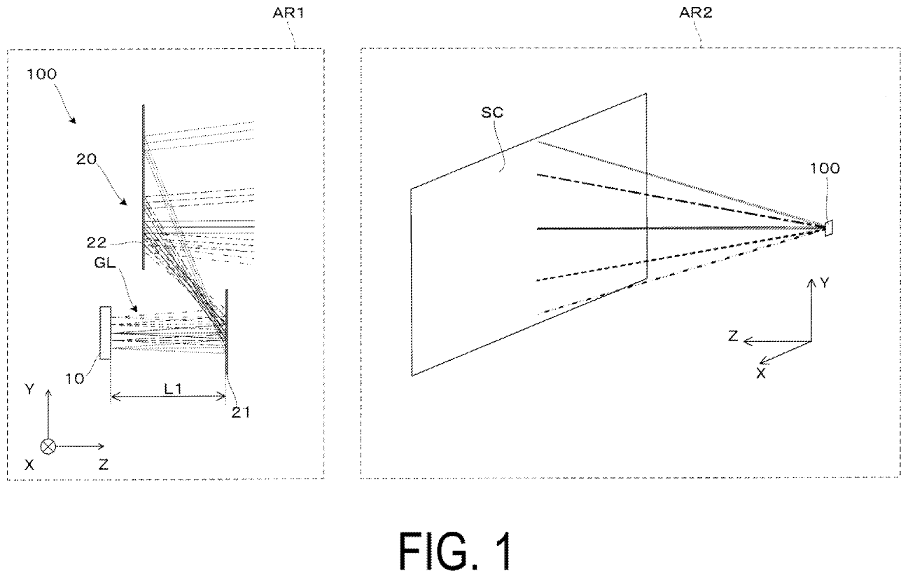

FIG. 1 is a conceptual diagram for explaining the projector 100 of the first embodiment, state AR1 in FIG. 1 shows a conceptual side cross-sectional view of the projector 100, and state AR2 shows a conceptual perspective view of how the projector 100 performs projection onto a screen SC. As shown in state AR1 of FIG. 1, the projector 100 includes a display element 10 and a light guide device 20. The light guide device 20 includes a first diffraction element 21 and a second diffraction element 22.

In FIGS. 1 to 7, X, Y, and Z form an orthogonal coordinate system and the +Z direction indicates a direction in which image light GL is emitted from the display element 10 and corresponds to an optical axis direction. The X direction corresponds to a lateral direction of the display element 10 (a horizontal direction) and the Y direction corresponds to a longitudinal direction (a vertical direction) perpendicular to the lateral direction (horizontal direction).

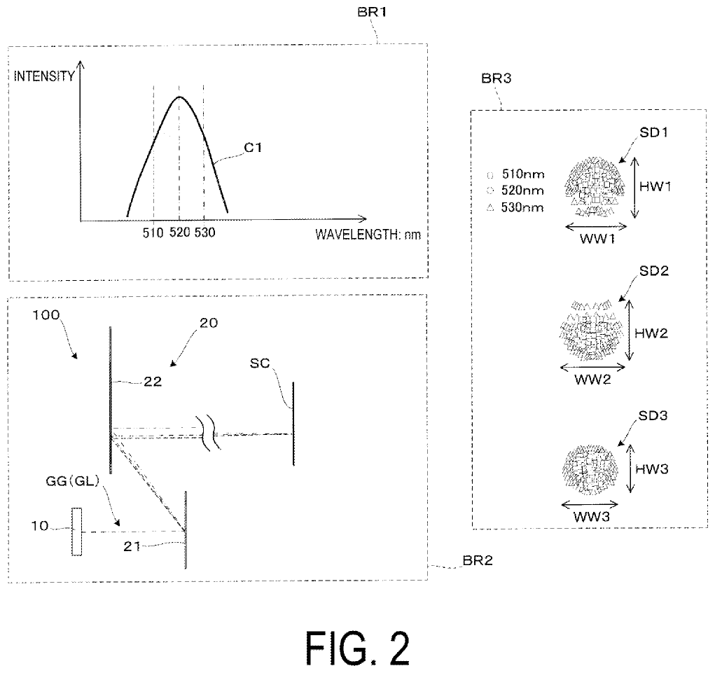

The display element 10 is a self-luminous display device that forms a color still image or moving image on a two-dimensional display portion parallel to the XY plane. The display element 10 is configured, for example, using an organic electroluminescent (EL) element, an inorganic EL element, an LED array (a micro LED array), an organic LED array, a laser array, or a quantum dot light-emitting element. Configuring the display element 10 such that it can emit light with high brightness eliminates the need for a separate light source and a large power supply unit that supplies power to the light source and allows the projector 100 to be made compact and light as a whole. As shown, the display element 10 emits multicolor image light GL toward the light guide device 20, that is, in the +Z direction. Here, a self-luminous display element that uses, for example, an organic EL element is adopted as an example of the self-luminous display element 10. In this case, the image light GL emitted from the display element 10 has a predetermined wavelength band for each color of light. An example of the wavelength band will be described later in more detail with reference to FIG. 2.

The first and second diffraction elements 21 and 22 of the light guide device 20 are reflective hologram elements and are arranged facing each other as shown in FIG. 1. Here, it is conceivable that volume holograms be used as the reflective hologram elements, but the reflective hologram elements may also be configured using other hologram elements.

The first diffraction element 21 diffracts the image light GL from the display element 10. The image light GL diffracted by the first diffraction element 21 travels toward the second diffraction element 22.

The second diffraction element 22 diffracts the image light GL that has passed by the first diffraction element 21 and emits the image light GL diffracted by the second diffraction element 22.

The image light GL that has passed by the second diffraction element 22 is emitted toward the screen SC to form an image as illustrated in state AR2. That is, the image light GL that has passed by the second diffraction element 22 is projected toward the screen SC as projection light from the projector 100.

In the above example, an air layer is formed between the display element 10, the first diffraction element 21, and the second diffraction element 22.

The projector 100 can be made very thin by arranging the first and second diffraction elements 21 and 22, which are plate-shaped reflective diffraction elements, such that they face each other as described above. In particular, in the above example, each of the first and second diffraction elements 21 and 22 of the light guide device 20 is a reflective hologram produced by simultaneous exposure to light of three colors, red light (R light), green light (G light), and blue light (B light). That is, each of the first and second diffraction elements 21 and 22 has a one-layer structure (a single-piece configuration). When the first and second diffraction elements 21 and 22 are compared in the shown example, the first diffraction element 21 located on an upstream side of the optical path is smaller than the second diffraction element 22 located on a downstream side of the optical path.

In the above example, the combination of the first and second diffraction elements 21 and 22 can prevent color separation due to diffraction when the image light GL is guided by the light guide device 20. In particular, in the above example, a display element that emits multicolor image light GL having a predetermined wavelength band for each color of light such as an organic EL element is employed as the display element 10. A volume hologram having a refractive index distribution is also adopted as each of the diffraction elements 21 and 22. In such a configuration, even single-color light may undergo color separation depending on the width of the wavelength band. The first embodiment prevents color separation in consideration of such a situation, thereby achieving highly efficient use of light.

The occurrence and elimination of angular separation in the first embodiment will be described below with reference to the conceptual diagram shown as FIG. 2. Here, an example will be described with respect to green light (G light) among the red light (R light), green light (G light), and blue light (B light) as a representative. The same is applied to light of other colors and description thereof is omitted.

State BR1 in FIG. 2 shows a graph showing the wavelength characteristics of green light GG included in the image light GL from the display element 10. State BR2 shows optical paths, depending on wavelength, of the components of green light GG of the image light GL along principal rays from the center of the panel of the display element 10. State BR3 shows spot diagrams on the screen SC for three angles of view.

First, in the graph shown in state BR1, a horizontal axis represents wavelength (in nm), a vertical axis represents light intensity, and a curve C1 represents a wavelength distribution of green light (G light). In the curve C1, a peak wavelength is 520 nm and a range up to about ±10 nm from the peak wavelength corresponds to a main component band (for example, a half width) of the green light (G light). Here, the peak wavelength component of 520 nm is defined as a first green component GG1, the component of 510 nm (=520−10 nm) is defined as a second green component GG2, and the component of 530 nm (=520+10 nm) is defined as a third green component GG3. In connection with this, in state BR2, the optical path of the first green component GG1 among the components is indicated by a one-dot chain line, the optical path of the second green component GG2 is indicated by a broken line, and the optical path of the third green component GG3 is indicated by a two-dot chain line. As shown in state BR2, angular separation occurs between the first to third green components GG1 to GG3 when diffracted by the first diffraction element 21 due to a wavelength difference of about ±10 nm with respect to the peak wavelength. On the other hand, in the second diffraction element 22, compensation is made to eliminate the angular separation that has occurred. That is, after passing by the second diffraction element 22, the first to third green components GG1 to GG3 are projected onto the screen SC in a state of being collimated or nearly collimated.

Regarding the above, it is conceivable to employ a mode in which light is projected toward the screen SC in a state of being collimated by the second diffraction element 22, for example, when the positional deviation between the first to third green components GG1 to GG3 due to the angular separation caused by the first diffraction element 21 is small, but there may be a case where the positional deviation between the first to third green components GG1 to GG3 is equal to or more than a certain amount. In such a case, it is conceivable to make compensation such that, after passing by the second diffraction element 22, the green light GG is made nearly collimated while its entire light ray bundle containing the first to third green components GG1 to GG3 is slightly condensed. That is, it is possible to employ a mode in which the compensation relationship between the first and second diffraction elements 21 and 22 is made slightly deviated from a perfect state.

While state BR2 shows the optical paths along the principal rays from the center of the panel, components other than those from the center of the panel can also be projected onto the screen SC in a state of being subjected to similar compensation. As described above, divergent light emitted from each pixel of the display element 10 also becomes condensed on the screen SC as shown in state BR3. Specifically, the spot diagrams SD1 to SD3 shown in state BR3 show a condensed state of the first to third green components GG1 to GG3 passing through optical paths of a lower angle of view, a condensed state of the first to third green components GG1 to GG3 passing through optical paths of an upper angle of view, and a condensed state of the first to third green components GG1 to GG3 passing through optical paths of a central angle of view, respectively. It is possible to form an image with a sufficiently high resolution by making respective vertical widths HW1 to HW3 and horizontal widths WW1 to WW3 of the spot diagrams SD1 to SD3 within desired ranges. In the spot diagrams SD1 to SD3 in FIG. 2, some components on which others are superimposed among the first to third green components GG1 to GG3 are not visible although they are present. For example, third green components GG3 are also present at a center portion of the spot diagram SD3. It is also conceivable that the diameters of the spot diagrams on the screen SC be made within desired ranges by adjusting the compensation for angular separation as necessary as described above.

As described above, the second diffraction element 22 emits the image light GL such that it is condensed at a predetermined position (a position on the screen SC).

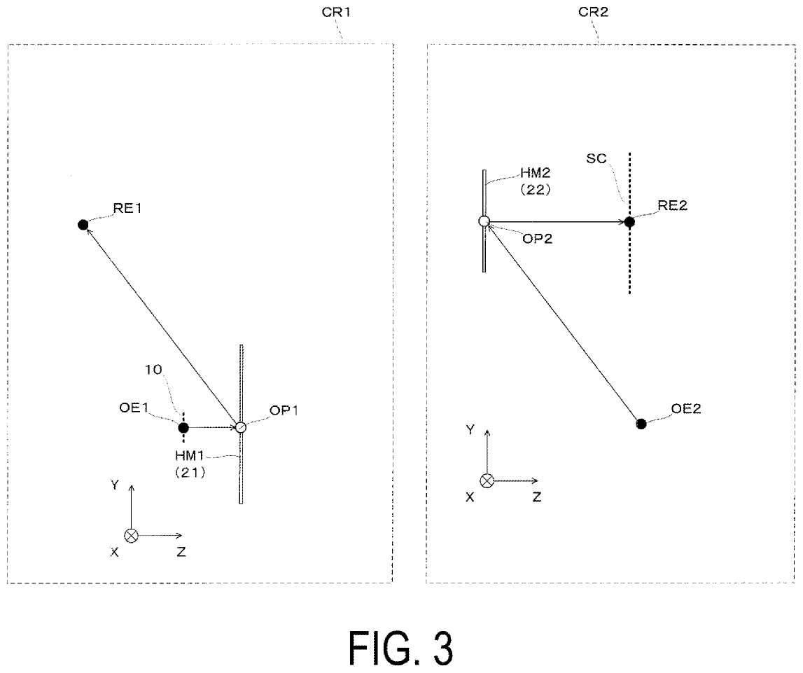

Hereinafter, the production of hologram elements to be used as the first and second diffraction elements 21 and 22 will be described with reference to the conceptual diagram shown as FIG. 3. Here, in particular, exposure points in the production of the hologram elements will be described.

State CR1 in FIG. 3 shows a positional relationship between a reference-side exposure point RE1 and an object-side exposure point OE1 where a position on a hologram material HM1 to be used as the first diffraction element 21, which corresponds to the center of the first diffraction element 21, is at an origin OP1. In this case, it is assumed that, when the YZ coordinates of the origin OP1 are (0, 0), the coordinates of the object-side exposure point OE1 are, for example, (0, −3) and the coordinates of the reference-side exposure point RE1 are, for example, (800, −600). Here, a unit coordinate interval corresponds to a length of 1 mm.

Similarly, state CR2 shows a positional relationship between a reference-side exposure point RE2 and an object-side exposure point OE2 where a position on a hologram material HM2 to be used as the second diffraction element 22, which corresponds to the center of the second diffraction element 22, is at an origin OP2. In this case, it is assumed that, when the YZ coordinates of the origin OP2 are (0, 0), the coordinates of the object-side exposure point OE2 are, for example, (−800, 600) and the coordinates of the reference-side exposure point RE2 are, for example, (0, 350).

Although the above coordinates of the points can take various values depending on the configuration or the like, the points are can be set, for example, such that the object-side exposure point OE1 among the above points corresponds to the center of the panel of the display element 10 and the reference-side exposure point RE2 corresponds to the center position of an image formed on the screen SC such that the light guide device 20 including the first and second diffraction elements 21 and 22 functions as one optical system. However, the relative difference between the distance from the position of the panel of the display element 10 to the first diffraction element 21 and the distance from the second diffraction element 22 to the projection position on the screen SC tends to increase in the above configuration. Thus, it is not always necessary to make the diffraction effects of the first and second diffraction elements 21 and 22 strictly correspond to each other and the degree of condensing may be appropriately adjusted to some extent depending on the positional deviation due to the angular separation as described above.

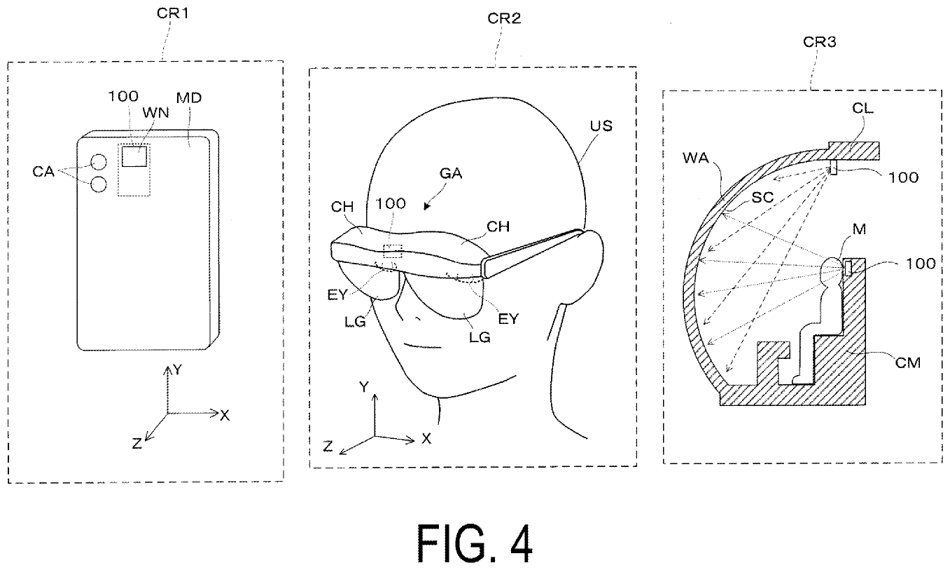

With the configuration as described above, the projector 100 according to the first embodiment can be made very thin and compact. For example, a distance L1 in the Z direction from the light-emitting surface of the display element 10 to the light-incident surface of the first diffraction element 21 shown in FIG. 1 can be made about 2 to 3 mm. Thus, for example, it is possible to employ a mode in which the projector 100 is further incorporated into a thin mobile device MD such as a smartphone equipped with various devices such as a camera CA and an image is projected from a window WN provided on the mobile device MD as illustrated in state CR1 of FIG. 4. It is also possible to employ a mode in which the projector 100 can be easily installed in eyeglasses GA worn by an observer or a wearer US and an image is projected onto the front real space in the line of sight of the observer or the wearer US as illustrated in state CR2 of FIG. 4. Further, the eyeglasses GA can be configured as a head-mounted display by adding a switching mechanism CH capable of projecting an image from the projector 100 onto eyeglass lenses LG of the eyeglasses GA. Also, the degree of freedom of installation of the projector 100 with respect to a viewer M is increased to facilitate the installation as illustrated in state CR3 of FIG. 4. The projector 100 can be easily installed on a seat CM of the viewer M or a ceiling CL and the viewer M can view an image using a wall surface of a wall WA as the screen SC. Here, the seat CM can also be the driver's seat of an automobile.

As described above, the projector 100 of the first embodiment includes the self-luminous display element 10 that emits multicolor image light GL having a predetermined wavelength band for each color of light, the first diffraction element 21 that diffracts the image light GL from the display element 10, and the second diffraction element 22 that emits the image light GL while making angular compensation for the angular separation of the image light GL, which has occurred depending on the wavelength band of light of each color when diffracted by the first diffraction element 21, by diffracting the image light GL. In the projector 100 described above, the multicolor image light GL emitted by the self-luminous display element 10 is guided and emitted through diffraction by the first and second diffraction elements 21 and 22, thereby achieving a reduction in the overall size of the apparatus, particularly a reduction in the overall thickness. In the above, a self-luminous display element that emits components having a predetermined wavelength band for each color of light as the image light GL is adopted as the self-luminous display element 10, and even if angular separation occurs depending on the wavelength band of light of each color when diffracted by the first diffraction element 21, the image light GL is emitted while angular compensation is made for the angular separation by the diffraction of the second diffraction element 22. Thereby, it is possible to emit high-brightness image light while saving power. Further, it is possible to achieve an appropriate condensed state of light on the projection surface in image projection, thus enabling high-definition image formation.

### Second Embodiment

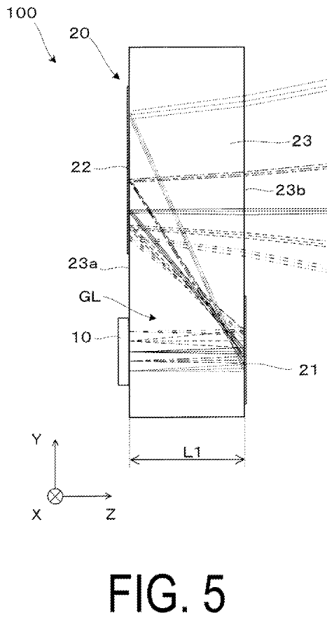

A projector according to a second embodiment will be described below with reference to FIG. 5. FIG. 5 is a conceptual side cross-sectional view for explaining an example of the projector 100 of the second embodiment and corresponds to the side cross-sectional view shown in state AR1 of FIG. 1. As shown, the second embodiment differs from the first embodiment in that a light guide device 20 is provided with a light-transmitting member 23 (with a thickness in the Z direction equal to the distance L1) which is a plate-shaped transparent member.

In the projector 100 illustrated in the first embodiment, an air layer is formed between the display element 10, the first diffraction element 21, and the second diffraction element 22, for example, as shown in state AR1 of FIG. 1. On the other hand, in the second embodiment, the light-transmitting member 23 is provided between them. That is, a display element 10, a first diffraction element 21, and a second diffraction element 22 are attached to predetermined positions on the plate-shaped light-transmitting member 23 whose thickness in the Z direction is equal to the distance L1 and image light GL is guided in the light-transmitting member 23. A more specific example of the manufacturing process of the projector 100 will be described. First, the display element 10 is adhered to one surface 23a of a transparent plate to be used as the light-transmitting member 23. Next, the first diffraction element 21 is attached to another surface 23b facing the surface 23a. Further, the second diffraction element 22 is attached to the surface 23a, to which the display element 10 has been attached, on the side (+Y side) thereof above the display element 10. As described above, the transparent plate functions as the light-transmitting member 23 described above. In this case, light diffracted by the second diffraction element 22 is refracted at the surface 23b of the light-transmitting member 23 in a range thereof facing the second diffraction element 22 and then emitted.

The projector 100 of the second embodiment as well emits the image light GL while making angular compensation for angular separation caused when diffracted, such that it is possible to emit high-brightness image light GL while saving power and further to enable high-definition image formation. Further, in the second embodiment, each part of the light guide device 20 is attached to and positioned on a thin plate such as the light-transmitting member 23, thereby enabling highly accurate mounting.

### Third Embodiment

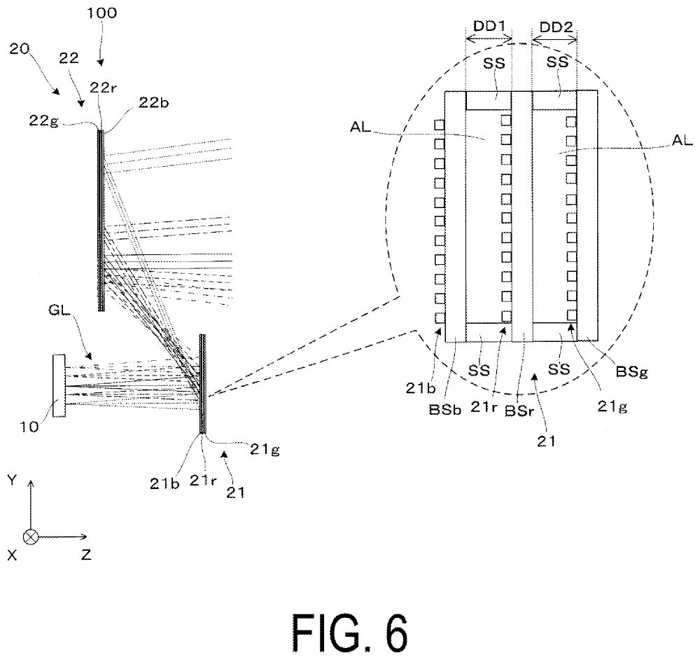

A projector according to a third embodiment will be described below with reference to FIG. 6. FIG. 6 is a conceptual side cross-sectional view for explaining an example of the projector 100 of the third embodiment and corresponds to the side cross-sectional view shown in state AR1 of FIG. 1 and the like. The structures of diffraction elements of the third embodiment differ from those of the first embodiment and the like. More specifically, in the third embodiment, each of the first and second diffraction elements 21 and 22 has a three-layer structure (a three-piece configuration). That is, the first diffraction element 21 includes a blue diffraction element 21b, a red diffraction element 21r, and a green diffraction element 21g and the second diffraction element 22 includes a blue diffraction element 22b, a red diffraction element 22r, and a green diffraction element 22g. Although a partially enlarged view conceptually shows details of the structure of only the first diffraction element 21, the second diffraction element 22 has the same structure as the first diffraction element 21 and detailed illustration and description thereof are omitted.

The configuration of the first diffraction element 21 will be described in more detail below with reference to FIG. 6. As shown, the first diffraction element 21 has a three-layer structure (a three-piece configuration) in which the blue diffraction element 21b, the red diffraction element 21r, and the green diffraction element 21g are stacked in the Z direction. That is, the blue diffraction element 21b is configured to exert a diffraction effect on blue light (B light) components included in the light of three colors, each having a predetermined wavelength band, which forms the image light GL from the display element 10, while transmitting light of the other colors without exerting no effect thereon. Similarly, the red diffraction element 21r is configured to exert a diffraction effect only on red light (R light) components and the green diffraction element 21g is configured to exert a diffraction effect only on green light (G light) components. Employing this configuration can further increase the utilization efficiency of light of each color.

The blue diffraction element 21b, the red diffraction element 21r, and the green diffraction element 21g, each for a corresponding wavelength band, have a thickness of about 20 to 40 μm, and are configured to be attached to light-transmitting resin or glass substrates BSb, BSr, and BSg. It is conceivable that the thicknesses of the substrates BSb, BSr, and BSg be approximately 0.3 mm, but they may be made thinner. The respective diffraction elements 21b, 21r, 21g attached to the substrates BSb, BSr, and BSg are fixed with intervals (gaps) DD1 and DD2 of about 50 μm therebetween. The intervals DD1 and DD2 are secured by attaching spacers SS to peripheral portions of the diffraction elements 21b, 21r and 21g where they exert no optical effect. Providing such intervals DD1 and DD2 form air layers AL between layers of the three-layer structure and thus can avoid the occurrence of unintended total reflection in the substrate BSb and the like. Moreover, employing the thickness described above allows the entire apparatus to maintain a certain degree of thinness in the Z direction even if the first and second diffraction elements 21 and 22 each have a three-layer structure.

In the shown first and second diffraction elements 21 and 22, the blue, red, and green diffraction elements are arranged in order from the light incident side, but the arrangement order is not limited to this and various arrangement modes are possible.

The projector 100 of the third embodiment as well emits the image light GL while making angular compensation for angular separation caused when diffracted, such that it is possible to emit high-brightness image light GL while saving power and further to enable high-definition image formation. Further, in the third embodiment, the first and second diffraction elements 21 and 22 are each provided with three diffraction elements corresponding to light of three colors, that is, each have a three-layer structure corresponding respectively to blue light (B light) components in a first color light wavelength band, red light (R light) components in a second color light wavelength band, and green light (G light) components in a third color light wavelength band included in the image light GL, such that it is possible to further increase the utilization efficiency of light. Furthermore, in the above three-layer structure, an air layer AL is provided between each layer, such that it is possible to avoid the occurrence of unintended total reflection of light of each color and to improve image projection.

Fourth embodiment

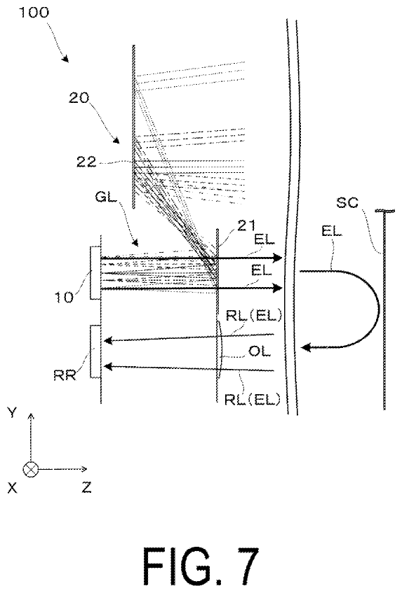

A projector according to a fourth embodiment will be described below with reference to FIG. 7. FIG. 7 is a conceptual side cross-sectional view for explaining an example of the projector 100 of the fourth embodiment and corresponds to the side cross-sectional view shown in state AR1 of FIG. 1 and the like. As shown, the fourth embodiment differs from the other embodiments in that a display element 10 projects component light EL of a transmission wavelength that passes through a first diffraction element 21 toward a screen SC as a component other than image light GL and a light receiving unit RR is provided to receive return light RL from the screen SC among the component light. More specifically, in the fourth embodiment, the first diffraction element 21 transmits, for example, a component other than the image light GL (a component other than visible light in a specific wavelength band) such as that of ultraviolet light and infrared light without exerting a diffraction effect thereon. In this case, it is conceivable to employ, for example, a mode in which the display element 10 is configured to emit light of a component in a wavelength band of infrared light as the component light EL, the light receiving unit RR is configured using a photodetector or the like capable of detecting components in a wavelength band included in the component light EL, and the display element 10 and the light receiving unit RR are separately arranged such that a light receiving surface of the light receiving unit RR is aligned with a light-emitting surface of the display element 10. For the component light EL emitted from the display element 10, it is conceivable to employ, for example, a method of arranging an infrared light array or the like in the panel of the display element 10.

In this case, by emitting component light EL (infrared light) forward (in the +Z direction) from the projector 100 as sensing light, it is possible to detect the position of the screen SC and further sense the shape of the projection surface. While an optical element OL for condensing the return light RL is provided in the shown example, various types of optical elements OL such as a diffraction element other than a lens can be used.

In the fourth embodiment as well, the image light GL is emitted while making angular compensation for angular separation caused when diffracted, such that it is possible to emit high-brightness image light while saving power and further to enable high-definition image formation. Further, in the fourth embodiment, the display element 10 emits the component light EL of the transmission wavelength that passes through the first diffraction element 21 in addition to the image light GL and the light receiving unit RR that receives the component light EL of the transmission wavelength detects return light RL and thereby can perform the sensing. Application of the sensing technology is particularly effective for the mobile device MD or the like equipped with the projector 100 of the fourth embodiment illustrated in state CR1 of FIG. 4 and can improve the quality of an image projected by the mobile device MD or the like.

### Modifications and Others

Although the present disclosure has been described with reference to the above embodiments, the present disclosure is not limited to the above embodiments and can be implemented in various modes without departing from the spirit of the disclosure. For example, the following modifications are possible.

In the projector 100 of each of the above embodiments, a self-luminous display element including an organic EL element, a micro LED array, or the like is used as the self-luminous display element 10, but the present disclosure can also be applied to one using a laser light source or the like instead of an organic EL element, a micro LED array, or the like. For example, if the laser light source may cause an error or the like in its generated wavelength band due to a temperature difference or the like, it is conceivable to employ a configuration in which diffraction corresponding to the angular separation is performed taking such an error into consideration.

Further, when the display element 10 is configured using an organic EL element, a micro LED array, or the like, the direction of the emitted image light GL may be adjusted using a microlens array or the like.

It is also possible to employ a configuration in which the modes illustrated in the above embodiments are appropriately combined within a range without contradiction. For example, it is conceivable that the configuration illustrated as the third embodiment or the fourth embodiment have the light-transmitting member 23 illustrated in the second embodiment.

The projector 100 of each of the above embodiments can also be adopted as one that constitutes a head-up display.

A projector according to a specific aspect includes a self-luminous display element configured to emit image light that is multicolored and has a predetermined wavelength band for each color of light, a first diffraction element configured to diffract the image light from the display element, and a second diffraction element configured to emit the image light while making angular compensation for angular separation of the image light occurring depending on the wavelength band of each color of light when diffracted by the first diffraction element, by diffracting the image light.

In the projector described above, the multicolor image light emitted by the self-luminous display element is guided and emitted through diffraction by the first and second diffraction elements, thereby achieving a reduction in the overall size of the apparatus. In the above, a self-luminous display element that emits components having a predetermined wavelength band for each color of light as the image light is adopted as the self-luminous display element, and even if angular separation occurs depending on the wavelength band of light of each color when diffracted by the first diffraction element, the image light is emitted while angular compensation is made for the angular separation by the diffraction of the second diffraction element. Thereby, it is possible to emit high-brightness image light while saving power. Further, it is possible to achieve an appropriate condensed state of light on the projection surface in image projection, thus enabling high-definition image formation.

In a specific aspect, the second diffraction element is configured to emit the image light such that the image light is condensed at a predetermined position. In this case, it is possible to form an image with sufficient accuracy.

In a specific aspect, the projector further includes a light-transmitting member to which the display element, the first diffraction element, and the second diffraction element are attached and in which the image light is guided. In this case, each part such as the display element is attached to and positioned on the light-transmitting member, thereby enabling highly accurate mounting.

In a specific aspect, an air layer is formed between the display element, the first diffraction element, and the second diffraction element. In this case, it is possible to avoid or reduce the occurrence of unintended total reflection or the like when guiding light, while achieving a simpler configuration.

In a specific aspect, each of the first diffraction element and the second diffraction element has a single-layer structure. In this case, it is possible to achieve a simple configuration and reduce the thickness of the apparatus.

In a specific aspect, each of the first diffraction element and the second diffraction element has a three-layer structure corresponding respectively to a first color light wavelength band, a second color light wavelength band, and a third color light wavelength band included in the image light. In this case, suitable diffraction is performed for each color of light, enabling highly efficient use of light.

In a specific aspect, an air layer is provided between each layer in the three-layer structure. In this case, it is possible to avoid or reduce the occurrence of unintended total reflection in the first diffraction element and the second diffraction element.

In a specific aspect, each of the first diffraction element and the second diffraction element is made of a volume hologram. In this case, it is possible to precisely produce an intended diffraction effect.

In a specific aspect, the first diffraction element is smaller than the second diffraction element. In this case, it is possible to reduce the size of the apparatus.

In a specific aspect, the display element is configured to emit, in addition to the image light, component light of a transmission wavelength that passes through the first diffraction element, and the projector further includes a light receiving unit configured to receive the component light of the transmission wavelength. In this case, it is possible to detect the position of the screen and perform sensing for determining the shape of the projection surface.

In a specific aspect, the display element includes either an organic electroluminescent element or a micro light-emitting diode array. In this case, it is possible to reliably ensure a stable intensity of light while reducing power consumption with a simple configuration.

What is claimed is:

1. A projector comprising:
a self-luminous display element configured to emit image light that is multicolored and has a predetermined wavelength band for each color of light;
a first diffraction element configured to diffract the image light from the display element; and
a second diffraction element configured to emit the image light while making angular compensation, by diffracting the image light, for angular separation of the image light occurring depending on the wavelength band of each color of light when diffracted by the first diffraction element.

2. The projector according to claim 1, wherein the second diffraction element is configured to emit the image light such that the image light is condensed at a predetermined position.

3. The projector according to claim 1, further comprising a light-transmitting member to which the display element, the first diffraction element, and the second diffraction element are attached and in which the image light is guided.

4. The projector according to claim 1, wherein an air layer is formed between the display element, the first diffraction element, and the second diffraction element.

5. The projector according to claim 1, wherein each of the first diffraction element and the second diffraction element has a single-layer structure.

6. The projector according to claim 1, wherein each of the first diffraction element and the second diffraction element has a three-layer structure corresponding respectively to a first color light wavelength band, a second color light wavelength band, and a third color light wavelength band included in the image light.

7. The projector according to claim 6, wherein an air layer is provided between each layer in the three-layer structure.

8. The projector according to claim 1, wherein each of the first diffraction element and the second diffraction element is made of a volume hologram.

9. The projector according to claim 1, wherein the first diffraction element is smaller than the second diffraction element.

10. The projector according to claim 1, wherein the display element is configured to emit, in addition to the image light, component light of a transmission wavelength that passes through the first diffraction element, and
the projector further comprises a light receiving unit configured to receive the component light of the transmission wavelength.

11. The projector according to claim 1, wherein the display element includes either an organic electroluminescent element or a micro light-emitting diode array.
